(19) United States
(12) Patent Application Publication
(10) Pub. No.: US 2010/0171323 A1
(43) Pub. Date: Jul. 8, 2010

(54) Latch for a vehicle door

(76) Inventor: James M. Helms, Fort Myers, FL (US)

Correspondence Address: KAREN TANG-WAI SODINI, 216 horseshoe drive, MARS, PA, 16046, US

(21) Appl. No.: 12/655,302

(22) Filed: Dec. 28, 2009

Related U.S. Application Data
(60) Provisional application No. 61/204,508, filed on Jan. 7, 2009.

(51) Int. Cl. E05C 3/12

(52) U.S. Cl. 292/259 A

(57) ABSTRACT

A latch for latching closed a door of a vehicle, especially designed to minimize the force required to latch closed the door by pushing the door to its closed position. A tongue, having a strike face and a catch face, is resiliently mounted in the latch so as to be urged to a latch-engaged position by a torsion spring pushing against a surface of the tongue and against a cover plate of the latch. A slider block is coupled to a door handle and to the tongue so that the tongue can be swiveled to a disengaged state by use of the door handle, in order to open the vehicle door.

### CROSS REFERENCE TO RELATED APPLICATION

Reference is made to and priority claimed from U.S. provisional application Ser. No. 61/204,508, filed on Jan. 7, 2009.

### FIELD OF THE INVENTION

The present invention pertains to the field of vehicles. More particularly, the present invention pertains to latches for utility vehicles, including such vehicles used for military and security applications.

### BACKGROUND OF THE INVENTION

In the war against terrorism, because of the increasing explosive force of IEDs (Improvised Explosive Devices) and other explosive devices used by terrorists, it has become desirable to provide more and more armor for military and security vehicles, to the point where the doors of some such vehicles weigh hundreds of pounds. If such a vehicle is stopped on an incline, an occupant may struggle to open the door, and in some cases may not be able to open the door at all.

In response, it has become necessary to develop motorized mechanisms for providing assistance in opening such doors.

Such doors have typically been provided with a primary door latch, including a tongue portion that is forced downward to an open position as the door is closed, and when the door closes the tongue springs back to its up position, so that the latch is then in its closed position and holds the door closed. To open the door a handle is used, which retracts the tongue, placing the latch in the open position and allowing the door to be pushed or pulled open.

Such latches for a door of a vehicle are intended to hold the door closed even in case of a violent explosion. Apparently with such a goal in mind, the latches have been designed so as to require significant force to close them, typically 40-90 pounds of spring force must be overcome in pushing the tongue of such a latch to the down position.

As the doors of such vehicles are increasingly more heavily armored and thus weigh more, the significant force required to place a latch of such a door in the open position by pushing or pulling on the open door in order to close it, imposes an additional, significant load on motorized door assist mechanisms.

What is needed is a latch that can be placed in a position allowing a door to be closed, without requiring undue force.

### Disclosure of Invention

Accordingly, the invention provides a latch, for mounting on a vehicle door, including a tongue coupled to a slider block via control links, arranged so that the tongue swivels downward (as opposed to being pushed downward) to a depressed state, to allow the vehicle door to close, and when the door closes, the tongue springs to an upward position, holding the door closed. The door is opened via a control rod pulling downward on the slider block, which in turn pulls the tongue to its depressed state.

### BRIEF DESCRIPTION OF THE DRAWINGS

The features and advantages of the invention will become apparent from a consideration of the subsequent detailed description presented in connection with accompanying drawings, in which:

FIGS. 1-11 are perspective drawings of a latch for a vehicle door, according to the invention, in various states of operation.

FIG. 12 is an exploded view perspective drawing of the latch of FIGS. 1-11.

### DRAWINGS LIST OF REFERENCE NUMERALS

The following is a list of reference labels used in the drawings to label components of different embodiments of the invention, and the names of the indicated components.
10 latch
10a slider spring
10b spring perch
10c spring perch member
10d anchor members
10e cover plate
10f slider block
10g aperture in the slider block
10h cutout portion of slider block
10j control link aperture or slider block aperture
10k tongue
10m strike face
10n catch face
10p apex portion
10q aperture
10r control link dowel pin
10s aperture
10t swivel dowel pin
10u cavity
10v torsion spring
10w elongated control link
10x slider dowel pin
10y side block
10z side block aperture
11a pin
11b control rod
12 fastener
14 vehicle door
14a window
15 door frame surface

### DETAILED DESCRIPTION

The invention provides a latch for a vehicle door, and in particular a latch that closes without undue force when the vehicle door is pushed closed.

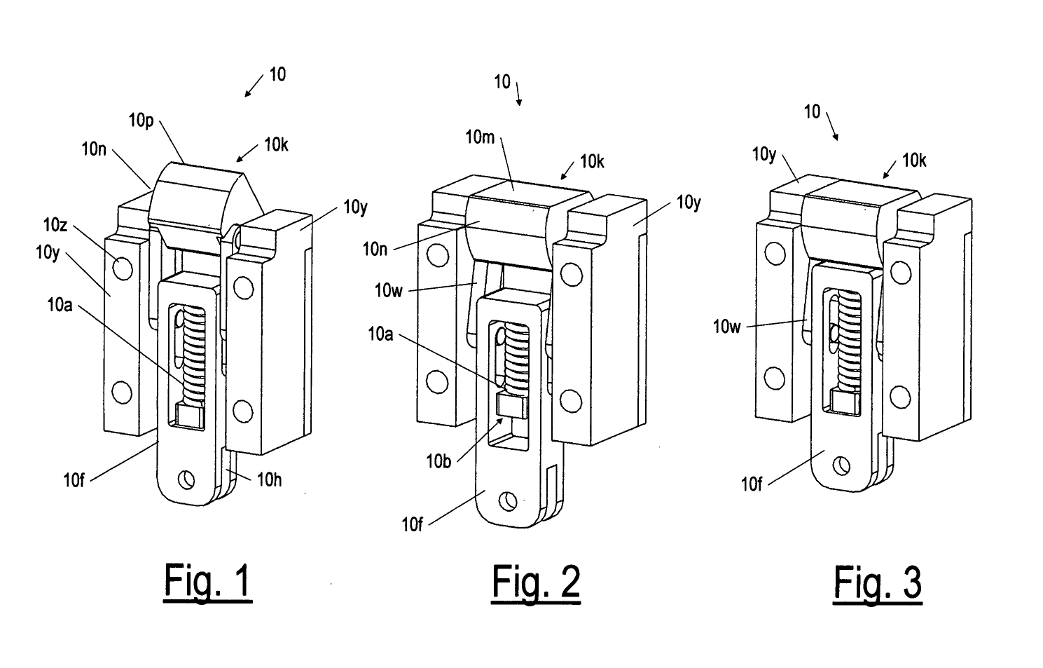

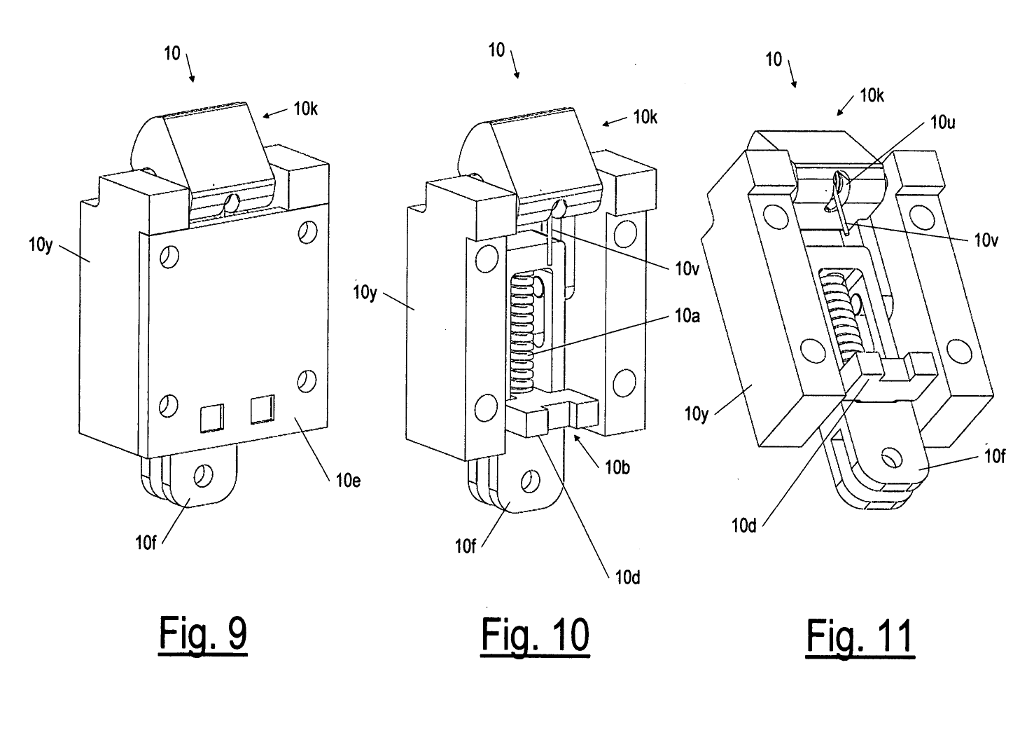

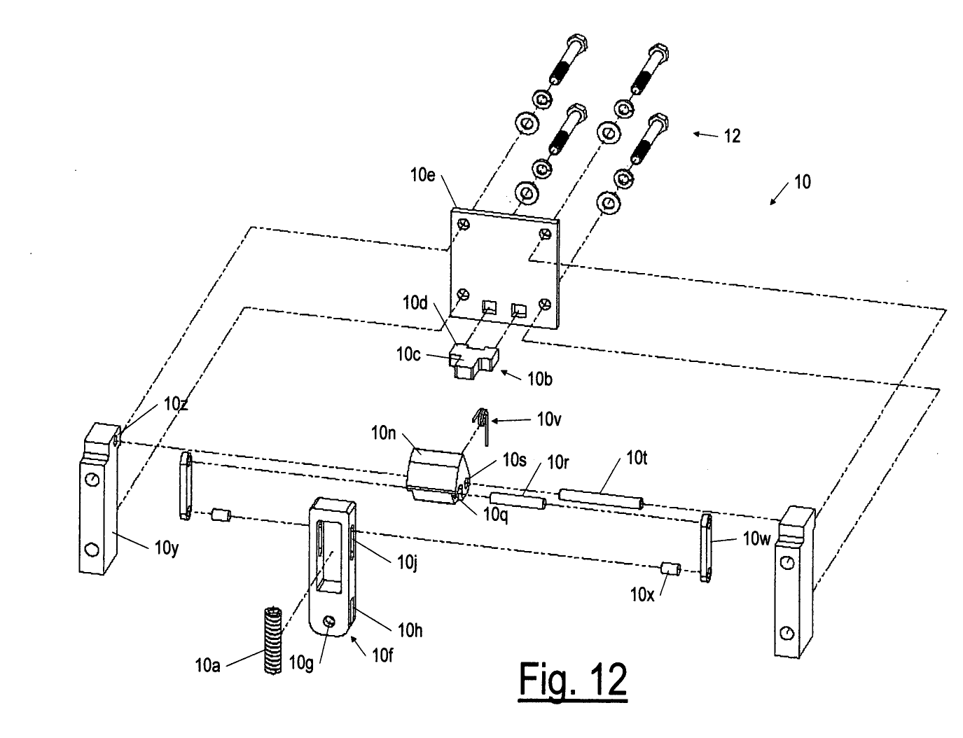

Referring now to FIGS. 1-12, the invention provides a latch 10, having a slider spring 10a mounted on a spring perch 10b. The spring perch has a spring perch member 10c (FIG. 12) for providing a stop for the slider spring, and also has protruding anchor members 10d (FIG. 12).

Referring now especially to FIG. 12, the latch has a cover plate 10e, having apertures for receiving fasteners 12 (FIG. 12) for attaching the door latch to the door, and having apertures for receiving the anchor members 10d of the spring perch 10b.

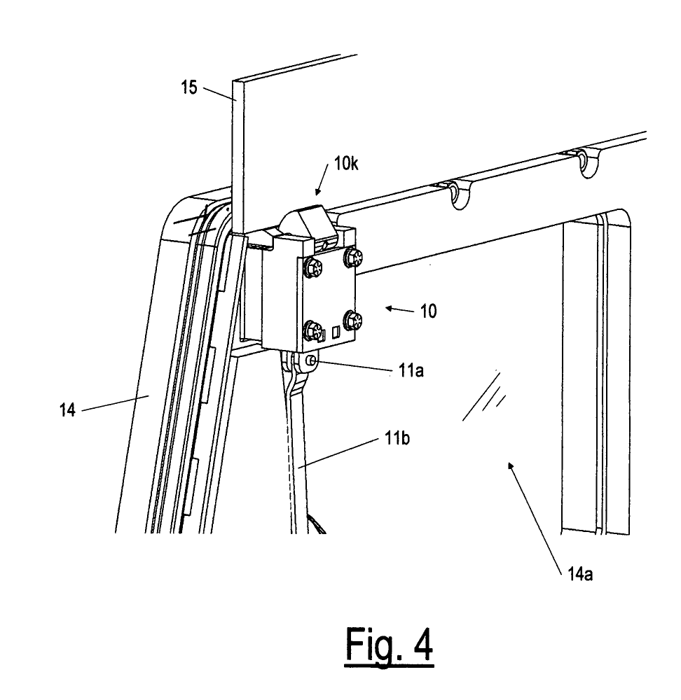

The spring perch member 10c protrudes into the bottom portion of an aperture of a slider block 10f, which aperture contains the slider spring 10a. The slider block 10f also has an aperture 10g for receiving a pin 11a (FIG. 4) for coupling the slider block to a control rod 11b coupled to a door handle (not shown). The slider block has a cutout portion 10h for receiving the control rod and disposed so that the pin passes through the cutout portion, and has two control link apertures 10j, each opening into the aperture for holding the slider spring, from an opposite side of the slider block.

The latch 10 also includes a tongue 10k, provided as a body formed so as to have a substantially planar strike face 10m and a curved catch face 10n (see especially FIGS. 1 and 2) meeting at an apex portion 10p of the tongue, and having an aperture 10q (FIG. 12) proximate to the catch face for receiving a control link dowel pin 10r, and having an aperture 10s proximate the strike face for receiving a swivel dowel pin 10t (FIG. 12), and having a cavity 10u (FIG. 11) aligned with and encompassing a portion of the aperture proximate the strike face. Within the cavity 10u is mounted a torsion spring 10v having two arms, disposed within the cavity, and having a coiled portion forming an annular body pierced by the swivel pin 10t and oriented so as to urge a pivoting of the tongue about the swivel dowel pin in a direction away from the slider block, by one arm pushing against the cover plate 10e and the other arm pushing against a surface of the tongue 10k.

The latch 10 also includes two elongated control links 10w each having an aperture at an uppermost end and also at a lowermost end, and two slider dowel pins 10x. The two control links are disposed on opposite sides of the slider block 10f, and each is coupled to the slider block via a respective one of the slider dowel pins 10x extending from a respective one of the lowermost apertures into the proximate slider block aperture 10j. Each control link is also coupled to the tongue via the control link dowel pin 10r extending out from both sides of the tongue into the uppermost apertures of the control links.

Finally, the latch 10 also includes two side blocks 10y, each having apertures 10z for receiving a respective one or more of the fasteners 12 (FIG. 12) for attaching the door latch to the vehicle door (as shown in e.g. FIG. 4). The side blocks 10y are disposed on opposite sides of the slider block 10f, and each has an aperture 10z for receiving the swivel dowel pin 10t on which the tongue swivels relative to the two side blocks.

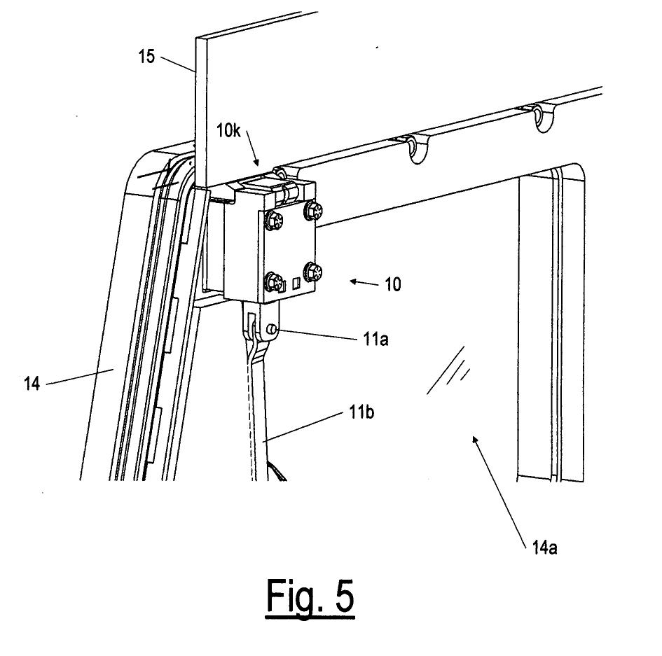

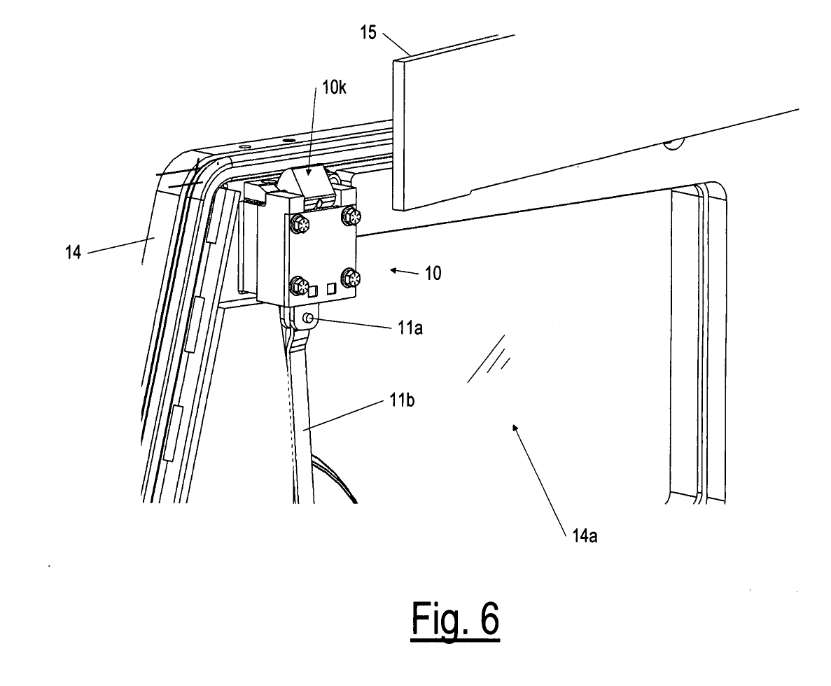

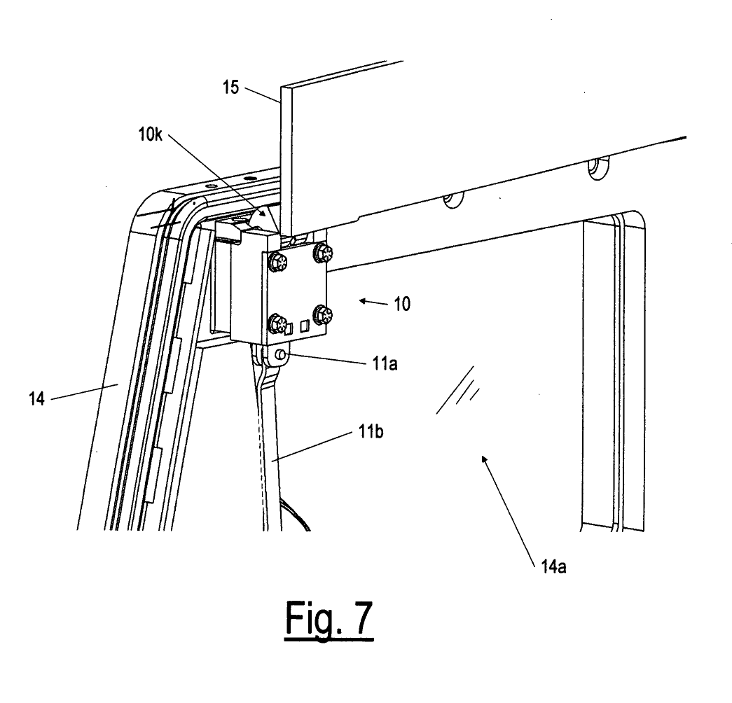

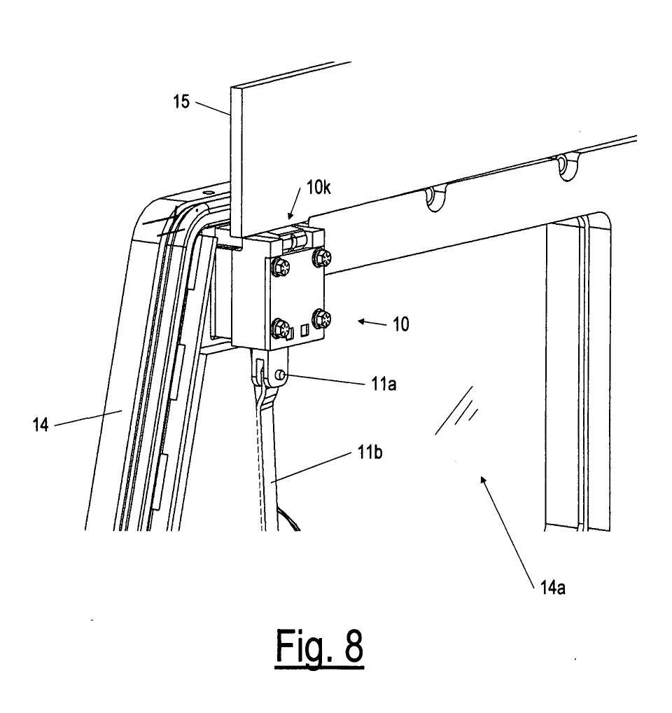

Operation of the latch 10 is most easily understood by reference to FIGS. 4-8, which shows the latch mounted on a vehicle door 14 having a window 14a. The door is made to close on a vehicle body having a door frame surface 15 (FIG. 4). In FIG. 4, the door is closed. In FIG. 5, the door is being opened (by an occupant of the vehicle using a handle to pull down on the control rod 11b). In FIG. 6, the door is swinging open. In FIG. 7, the door is swinging closed, and the tongue 10k is about to strike the door frame surface 15. In FIG. 8, the closing of the door has caused the tongue to depress, and the door is continuing to its final closed position, shown in FIG. 4.

Thus, in FIG. 4, the door is closed. In the closed position, the tongue 10k is held in its up position by the combined urging of the slider spring 10a and torsion spring 10v (FIG. 10). The state of the latch (i.e. whether the tongue is up or down, etc.) in FIG. 4 is the same as the state of the latch in FIGS. 1 and 9-11.

FIGS. 2 and 5 show the latch when the door handle (not shown) is used to pull down on the control rod 11b, to release the latch, and so allow the door to open (which is shown in FIG. 6). The spring perch 10b (FIG. 10) remains (at all times) in a fixed position relative to the door, but as the door handle (under a force exerted by a vehicle occupant) pulls down on the control rod 11b, the control rod in turn pulls the slider block 10f downward, and the slider block in turn pulls the tongue 10k downward to a depressed orientation, via the control links 10w. In this action, the tongue swivels on the swivel dowel pin 10t extending into the two side blocks 10y (FIG. 12).

FIGS. 3 and 8 show the latch while the door is closing, but not yet closed all the way, at the point where the tongue 10k is located directly beneath the door frame 15. The closing of the door causes the tongue to strike the door frame, with the result that the tongue swivels to a down position, on the swivel dowel pin 10t, so that the strike face of the tongue faces the bottom of the door frame (i.e. faces upward). Note that the slider block 10f does not move while the tongue 10k is being depressed as the door is closing. FIG. 4 shows the door in the final, closed position.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A door latch for a door of a vehicle, comprising:
a slider spring (10a);
a spring perch (10b), having a spring perch member (10c) for providing a stop for the slider spring, and having protruding anchor members (10d);
a cover plate (10e), having apertures for receiving fasteners (12) for attaching the door latch (10) to the door (14), and having apertures for receiving the anchor members (10d) of the spring perch (10b);
a slider block (10f), having an aperture for holding the slider spring (10a) and for receiving the spring perch member (10c), having an aperture (10g) for receiving a pin (11a) for coupling the slider block (10f) to a control rod (11b) coupled to a door handle, having a cutout portion for receiving the control rod (11b) and disposed so that the pin (11a) passes through the cutout portion, and having two control link apertures (10j) each opening into the aperture for holding the slider spring (10a), from an opposite side of the slider block (10f);
a tongue (10k), provided as a body formed so as to have a substantially planar strike face (10m) and a curved catch face (10n) meeting at an apex portion (10p) of the tongue (10k), and having an aperture (10q) proximate to the catch face (10n) for receiving a control link dowel pin (10r), and having an aperture (10s) proximate the strike face (10m) for receiving a swivel dowel pin (10t), and having a cavity (10u) aligned with and encompassing a portion of the aperture proximate the strike face (10m);
a torsion spring (10v) having two arms, disposed within the cavity (10u), and having a coiled portion pierced by the swivel pin (10t) and oriented so as to urge a pivoting of the tongue (10k) about the swivel dowel pin (10t) in a direction away from the slider block (10f), by one arm pushing against the cover plate (10e) and the other arm pushing against a surface of the tongue (10k);
two elongated control links (10w) each having an aperture at an uppermost end and also at a lowermost end, and two slider dowel pins (10x), the two control links (10w) disposed on opposite sides of the slider block (10f), each coupled to the slider block (10f) via a respective one of the slider dowel pins (10x) extending from a respective one of the lowermost apertures into the proximate slider block aperture (10j), wherein each control link (10w) is also coupled to the tongue (10k) via the control link dowel pin (10r) extending out from both sides of the tongue (10k) into the uppermost apertures of the control links (10w); and
two side blocks (10y), each having apertures (10z) for receiving a respective one or more of the fasteners (12) for attaching the door latch (10) to the door, disposed on opposite sides of the slider block (10f), and each having an aperture (10z) for receiving the swivel dowel pin (10t) on which the tongue (10k) swivels relative to the two side blocks (10y).
